(19) United States
(12) Patent Application Publication
(10) Pub. No.: US 2008/0031004 A1
(43) Pub. Date: Feb. 7, 2008

(54) LED vehicle lamp structure

(75) Inventor: Sing Chu, Taipei City (TW)

Correspondence Address: BACON & THOMAS, PLLC, 625 SLATERS LANE, FOURTH FLOOR, ALEXANDRIA, VA, 22314, US

(73) Assignee: DJ Auto Components Corp., Kui-Hsan Hsiang (TW)

(21) Appl. No.: 11/653,996

(22) Filed: Jan. 17, 2007

(30) Foreign Application Priority Data
Aug. 3, 2006 (TW) 095213677

(51) Int. Cl. B60Q 1/00

(52) U.S. Cl. 362/545; 362/507; 362/541

(57) ABSTRACT

A LED vehicle lamp structure installed in a vehicle lamp assembly comprising a housing, a lens, and a reflector is disclosed to include standing boards each having a top edge, a bottom edge, a height defined between the top edge and the bottom edge, and LEDs. By means of the arrangement of the LEDs on the standing boards to match with the heights of the standing boards between the respective top edges and the respective bottom edges, the light-emitting heads of the LEDs constitute an array that fits the variation of the curvature of the reflector and lens of the vehicle lamp assembly, thereby greatly lowering the cost and the manufacturing difficulty of the vehicle lamp assembly.

### BACKGROUND OF THE INVENTION

1. Field of the Invention

The present invention relates to LED (Light Emitting Diode) lamps and more particularly, to a LED vehicle lamp structure practical for use in a vehicle headlamp or tail lamp.

2. Description of Related Art

For the sack of safety driving and giving a warning or stop signal at night, a car generally has a tail lamp on the rear side.

Following the popularity of the application of LEDs (Light Emitting Diodes), LED lamps have been intensively used in motor vehicles for the advantages of power saving, quick reaction speed, small size, and long service life. In addition to the purpose of illumination, different tail lamps of LED arrays have been intensively used to substitute for conventional lamp bulb type tail lamps.

To fit different outer appearance designs, different shapes and sizes of tail lamps are used for different models of cars. Despite the variation on the shape or size, regular tail lamps commonly comprise a lens, a bazel, and a housing. The outer lens may have a smoothly arched curvature to fit the streamline outer appearance of the car or to show an active design.

To fit the curvature design of the outer lens and the requirements of related regulations and to provide sufficient illumination, the LED array of a tail lamp must be arranged at different elevations. According to conventional designs, spacer members, a stepped board, or a specially designed bazel may be used to support LEDs at different elevations subject to the variation of the curvature of the lens.

FIG. 9 shows the use of spacer members of different heights to support LEDs at different elevations subject to the variation of the curvature of the lens. Further, a specially designed bazel having reflecting wells of different depths may be used to hold LEDs at different elevations subject to the variation of the curvature of the lens. When using spacer members or a specially designed bazel in a LED lamp having a lens of which the variation of the curvature changes drastically, the heights of the spacer members or the depths of the reflecting wells may limit the angle of diffusion of the light of the LEDs. Therefore, the method of using spacer members or a specially designed bazel to support LEDs at different elevations is not applicable to a LED lamp having a lens of which the variation of the curvature changes drastically.

FIGS. 5 and 6 show the use a stepped board 91 in a LED vehicle lamp. According to this design, the stepped board 91 is molded from plastics. After installation of LEDs 94 in the stepped board 91, lead wires 93 and sockets (not shown) are used to electrically connect the LEDs 94 into an array. This installation procedure is complicated and wastes much labor and time. Further, the molding of the stepped board 91 and the use of the lead wires 93 installation tool means greatly increases the manufacturing cost of the LED vehicle lamp.

Therefore, it is desirable to provide a LED vehicle lamp structure that eliminates the aforesaid drawbacks.

### SUMMARY OF THE INVENTION

The present invention has been accomplished under the circumstances in view. According to one embodiment of the present invention, the LED (Light Emitting Diode) vehicle lamp structure is installed in a vehicle lamp assembly. The vehicle lamp assembly comprises a housing, a lens, and a reflector. The housing has a seat. The lens is fastened to the front side of the housing and covered over the seat. The reflector is sandwiched between the seat of the housing and the lens, having a plurality of lamp holes.

The LED vehicle lamp structure comprises a plurality of standing boards. Each standing board has a bottom edge, a top edge disposed opposite to the bottom edge, a height defined between the bottom edge and the top edge, and a plurality of LEDs (Light Emitting Diodes) respectively fixedly mounted on the standing boards adjacent to the top edges of the standing boards. The LEDs each have a light-emitting head and a leg unit.

The standing boards are respectively fastened to the seat of the housing and arranged in parallel to hold the LEDs in such a manner that the light-emitting heads of the LEDs are respectively inserted through the lamp holes of the reflector and suspending between the reflector and the lens.

By means of matching the LEDs with the standing boards to provide an array of light-emitting heads at different elevations, the simple structure of the invention successfully and effectively fits the variation of the curvature of any of a variety of lenses. Simply by changing the height between the top edge and bottom edge of each standing board or the bonding position of each LED, invention allows adjustment of the contour of the top edge of each standing board or the bonding position of the LEDs, the LED vehicle lamp structure fits the variation of the curvature of the reflector and the lens perfectly to provide the best illumination effect.

The standing boards are not limited to the parallel arrangement. Subject to the array design and amount of the LEDs and the whole structural design of the LED vehicle lamp structure, the standing boards may be arranged in a non-parallel manner or biased through an angle, i.e., the positioning of the standing boards may be changed subject to the design of the lens and housing of the LED vehicle lamp structure as desired.

Further, the standing boards include at least two standing boards that have different heights to fit the curvature of the lens.

Further, the standing boards include at least one standing board that has at least two LEDs disposed adjacent to the top edge of the associating standing board at different elevations to fit the curvature of the lens.

Further, the standing boards can be respectively formed of printed circuit boards, and the legs of the LEDs are directly soldered to the printed circuit boards. Alternatively, the standing boards can be commercial insulative boards. In this case, lead wires or like means are used to electrically connect the LEDs to power supply.

Further, the seat can be made having a plurality of mounting holes for the mounting of screws to detachably fasten the seat to the housing. Thus, the seat can be affixed to the housing of the vehicle lamp assembly after installation of the LED vehicle lamp structure. Alternatively, the seat can be formed integral with a part of the housing, or detachably fastened to the housing by any of a variety of joints or fastening means.

Further, the seat can be made having a plurality of guide grooves symmetrically provided on two opposite inside walls thereof. The standing boards are respectively inserted into the guide grooves of the seat and then fixedly secured to the seat with screws. Alternatively, the standing boards may be fastened to the seat by means of hook means, adhesive, or tight-fit.

Further, the guide grooves can be respectively formed integral with the two opposite inside walls of the seat.

Further, the seat can be made having fixedly mounted therein a circuit board, which has a plurality of insertion slots. The standing boards each have at least one gold leg respectively inserted into the insertion slots to electrically connect the respective LEDs to the circuit board in the seat without installation of additional lead wires.

Further, the LEDs can be red LEDs, green LEDs, blue LEDs, yellow LEDs, or white LEDs.

### BRIEF DESCRIPTION OF THE DRAWINGS

FIG. 1 is an exploded view of a LED vehicle lamp in accordance with a first embodiment of the present invention.

FIG. 2 is an enlarged view of a part of FIG. 1.

FIG. 3 is an assembly view of FIG. 2.

FIG. 4 is an exploded view of a LED vehicle lamp in accordance with a second embodiment of the present invention.

FIG. 5 is an exploded view of a LED vehicle lamp according to the prior art.

FIG. 6 is a schematic drawing of the LED array of the LED vehicle lamp according to the prior art.

FIG. 7 is a schematic drawing showing the installation angle of the light-emitting heads of the LEDs in a LED lamp relative to the lens according to the prior art.

FIG. 8 is a schematic drawing showing the installation angle of the light-emitting heads of the LEDs in a LED lamp relative to the lens according to the present invention.

FIG. 9 is a schematic drawing showing LEDs supported on respective spacer members according to the prior art.

### DETAILED DESCRIPTION OF THE PREFERRED EMBODIMENT

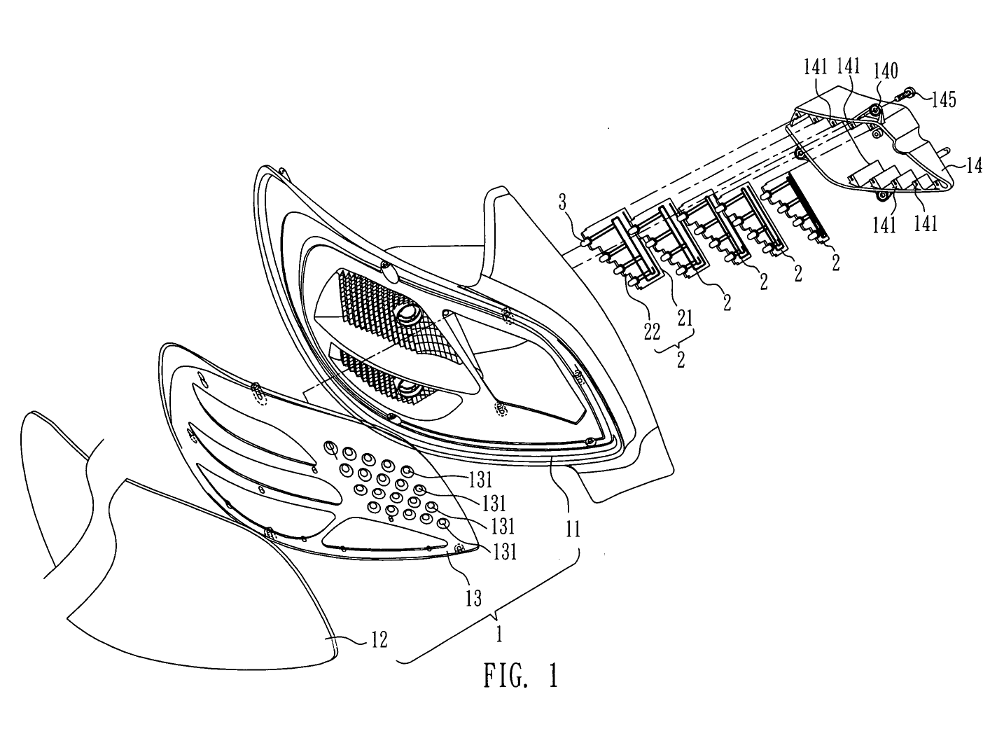

Referring to FIGS. 1˜3, a LED vehicle lamp structure in accordance with a first embodiment of the present invention is shown installed in a vehicle lamp assembly 1, which is comprised of a housing 11, a lens 12, and a reflector 13. The lens 12 is covered on the front side of the housing 11. The reflector 13 is sandwiched between a seat 14 of the housing 11 and the lens 12. The reflector 13 has five rows of lamp holes 131.

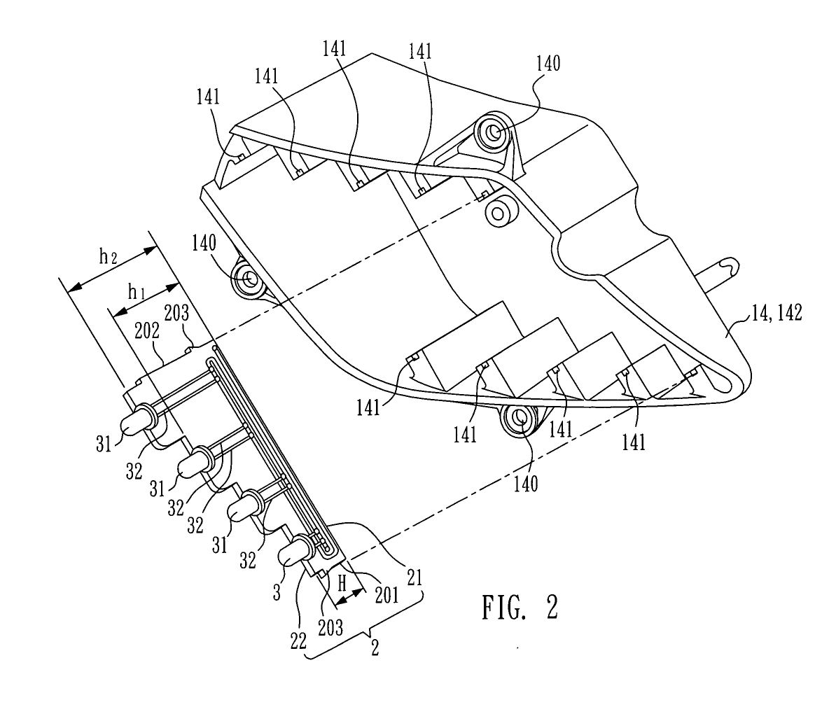

According to this embodiment, the seat 14 is formed of a waterproof box 142, having a plurality of mounting holes 140 on the top, left, and bottom sides (see FIG. 2). Screws 145 are respectively mounted in the mounting holes 140 to affix the seat 14 to the housing 11. Alternatively, the seat 14 may be formed integral with the housing 11, or fastened to the housing 11 by any of a variety of conventional mounting techniques. The seat 14 further has five guide grooves 141 on each of two opposite inside walls (see FIG. 2). The guide grooves 141 can be formed integral with the inside walls of the seat 14. Alternatively, the guide grooves 141 may be separately made and then respectively affixed to the inside walls of the seat 14.

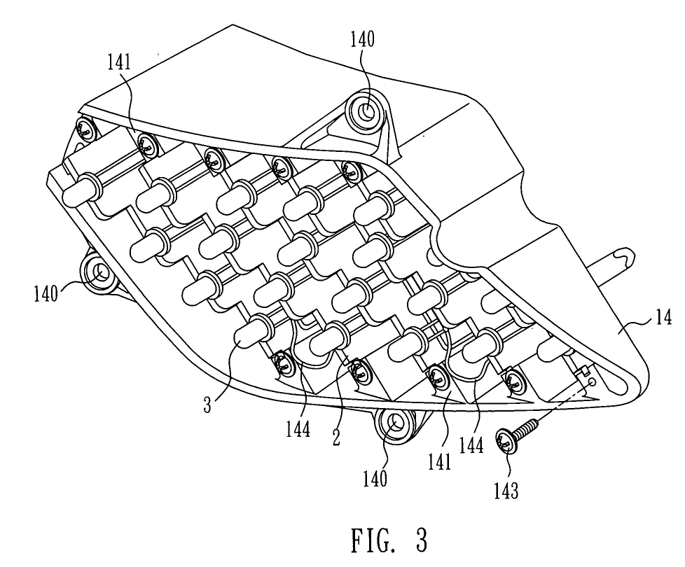

Further, there are provided five standing boards 2 as shown on the right upper side in FIG. 1. The standing boards 2 according to this embodiment are printed circuit boards having circuit means directly printed thereon. Alternatively, the standing boards 2 can be board members of other materials respectively mounted with electric wires to provide a respective circuit. Each standing board 2 has a bottom edge 21, a top edge 22, and two opposite side edges 201, 202. The bottom edge 21 and the top edge 22 are disposed at two opposite sides and spaced from each other at a height H (see FIG. 2). The opposite side edges 201, 202 of the standing boards 2 are respectively inserted into the guide grooves 141 inside the seat 14. When the bottom edges 21 of the standing boards 2 are stopped at the bottom wall of the seat 14 after insertion of the standing boards 2 into the respective guide grooves 141 inside the seat 14, barbed portions 203 that are respective protruded from the opposite side edges 201, 202 of the standing boards 2 are respectively hooked on a part of the seat 14 and affixed thereto with screws 143 (see FIG. 3). Tight-fit and other fastening methods may be selectively sued to affix the standing boards 2 to the seat 14.

Further, according to the example shown in FIG. 2, each standing board 2 has four LEDs 3 mounted thereon. Each LED 3 has a light-emitting head 31 and a set of legs 32. The legs 32 of the LEDs 3 are directly soldered to the printed circuits of the standing boards 2, supporting the light-emitting heads 31 of the respective LEDs 3 adjacent to the top edges 22 of the respective standing boards 2. According to this embodiment, the LEDs 3 on the upper left side are set at different elevations h1, h2 adjacent to the top edge 22 of the corresponding standing board 2 subject to the contour of the top edge 22 of the corresponding standing board 2. The contour of the top edge 22 of each standing board 2 or the bonding positions of the legs 32 of the LEDs 3 may be changed to fit different curvature requirements.

Further, the LEDs 3 according to this embodiment are red LEDs. However, white, green, blue, yellow, or other color LEDs may be used to substitute for red LEDs.

After installation of the standing boards 2 in the guide grooves 141 inside the seat 14, lead wires 144 are installed to electrically connect the printed circuits of the standing boards 2, so that the light-emitting heads 31 of the LEDs 3 form an array at different elevations (see FIG. 3). Further, the light-emitting heads 31 of the LEDs 3 are respectively inserted through the lamp holes 131 of the reflector 13 and suspending between the reflector 13 and the lens 12.

By means of matching the LEDs 3 with the standing boards 2 to provide an array of light-emitting heads 31 at different elevations, the simple structure of this embodiment successfully and effectively fits the variation of the curvature of any of a variety of lenses. This embodiment allows adjustment of the contour of the top edge 22 of each standing board 2 or the bonding position of the LEDs 3 to fit the variation of the curvature of the reflector and the lens, thereby eliminating the problem of the prior art design and significantly lowering the cost and the manufacturing difficulty, i.e., the simple design of the present invention achieves many benefits.

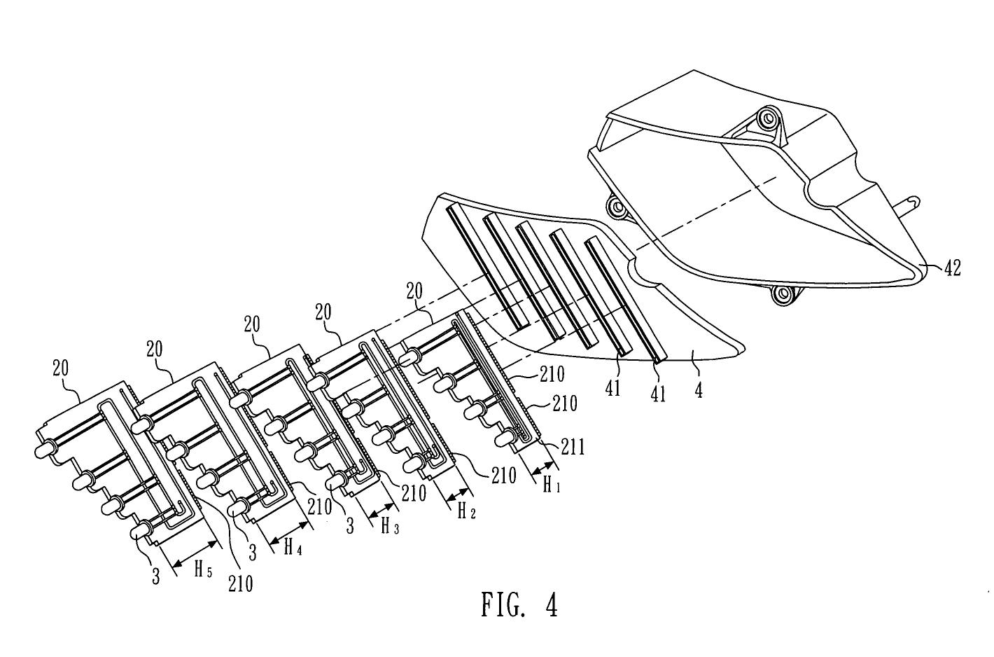

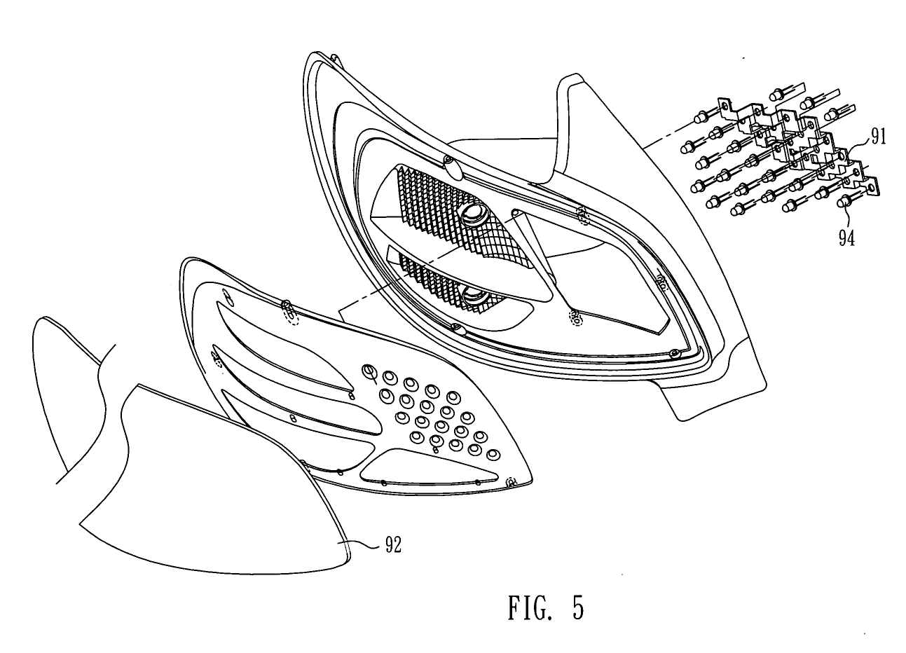

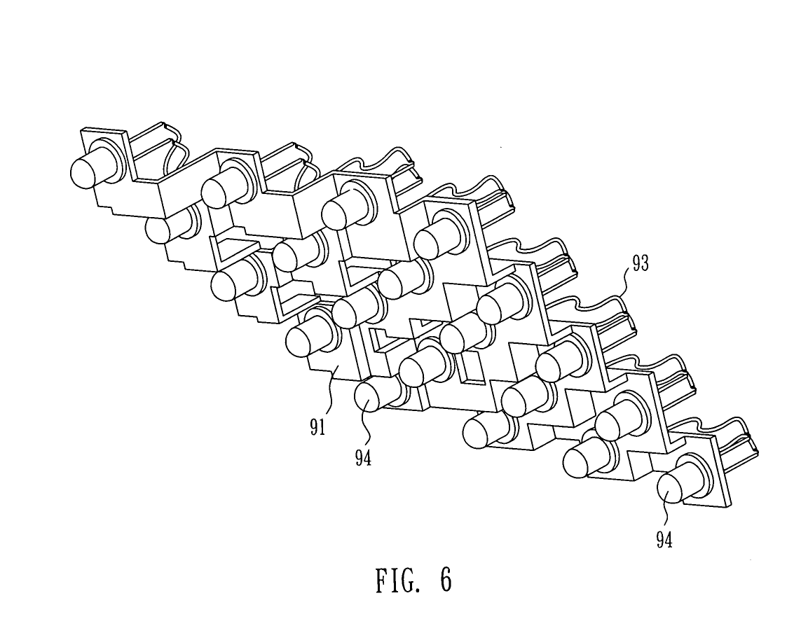

FIG. 4 shows a LED vehicle lamp structure in accordance with a second embodiment of the present invention. This second embodiment is substantially similar to the aforesaid first embodiment with the exception of the standing boards 20. According to this embodiment, the five standing boards 20 have a respective height H1-H5 to fit the significant variation of the curvature of the lens. Further, each standing board 20 has two gold legs 210 protruded from the respective bottom edge 211 and aligned in a line.

Further, the seat 42 has a circuit board 4 fixedly mounted on the inside. The circuit board 4 has five insertion slots 41 corresponding to the gold legs 210 of the standing boards 20. The gold legs 210 of the standing boards 20 are respectively and directly inserted into the insertion slots 41. Thus, the standing boards 20 are firmly fastened and electrically connected to the circuit board 4 without external lead wires, achieving the various effects of the aforesaid first embodiment of the present invention.

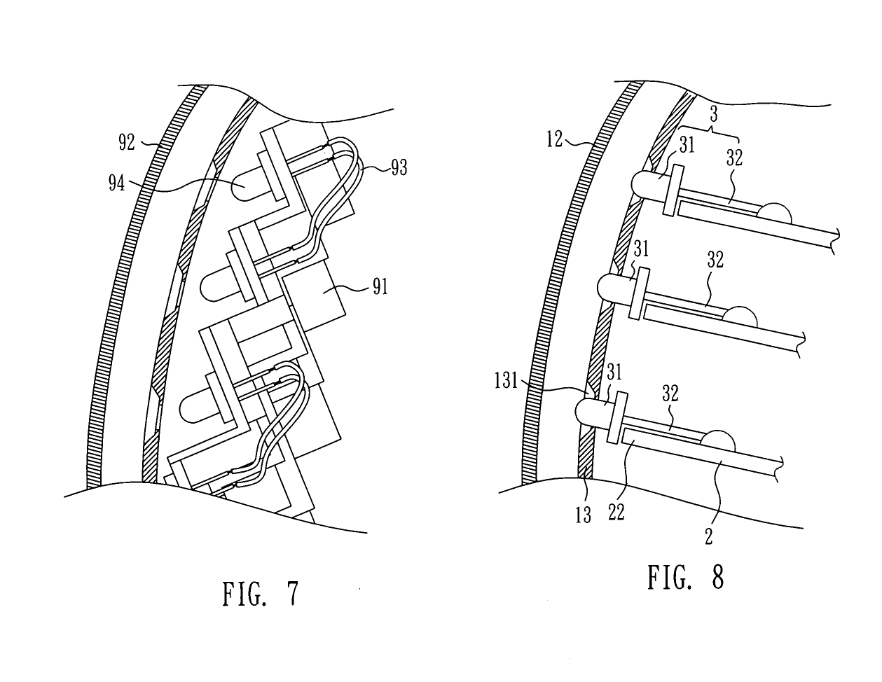

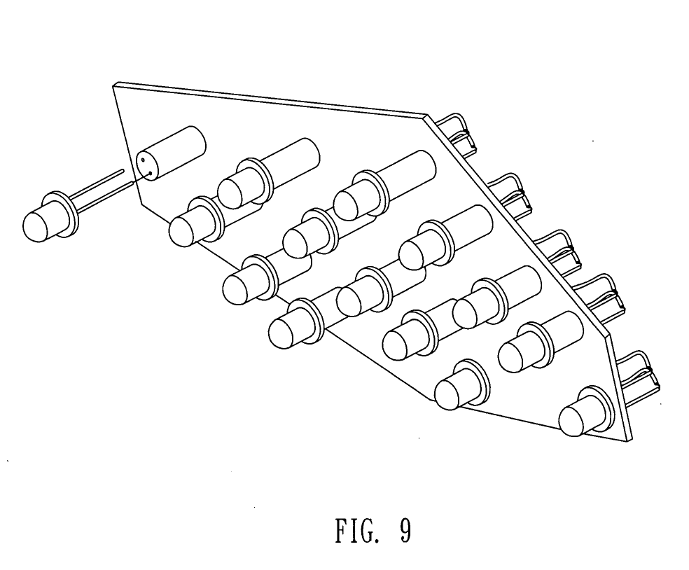

FIG. 7 is a schematic drawing showing the installation angle of the light-emitting heads of the LEDs in a LED lamp relative to the lens according to the prior art. FIG. 8 is a schematic drawing showing the installation angle of the light-emitting heads of the LEDs in a LED lamp relative to the lens according to the present invention.

As shown in FIG. 8, by means of the arrangement of the specially designed standing boards 2, the light-emitting heads 31 of the LEDs 3 are respectively disposed adjacent to the top edges 22 of the associating standing boards 2, and the legs 32 of the LEDs 3 are disposed in parallel to the associating standing boards 2 so that the light-emitting heads 31 of the LEDs 3 are respectively kept inserted through the lamp holes 131 of the reflector 13 and suspending between the reflector 13 and the lens 12, providing the best angle of illumination. This design is easy to install. According to the prior art design, the LEDs 94 that are carried on the stepped board 91 are not in perfect alignment with the corresponding lamp holes, i.e., the LEDs 94 are respectively aimed at the corresponding lamp holes at a peculiar angle, lowering the effect of illumination. Further, because the stepped board 91 is a plastic board, it becomes aged and deteriorated after a long use. When the stepped board 91 is aged and deteriorated, the angle of illumination of the LEDs 94 may be changed, bringing people and the car into danger.

Although the present invention has been explained in relation to its preferred embodiment, it is to be understood that many other possible modifications and variations can be made without departing from the spirit and scope of the invention as hereinafter claimed.

What is claimed is:

1. A LED vehicle lamp structure installed in a vehicle lamp assembly comprising a housing, a lens and a reflector, said housing having a seat, said lens being covered on a front side of said housing, said reflector being mounted inside said housing between said seat and said lens, said reflector having a plurality of lamp holes, the LED vehicle lamp structure comprising:
a plurality of standing boards, said standing boards each having a bottom edge, a top edge disposed opposite to said bottom edge, a height defined between said bottom edge and said top edge, and a plurality of light emitting diodes respectively fixedly mounted on said standing boards adjacent to the top edges of said standing boards, said light emitting diodes each having a light-emitting head and a leg unit;
wherein said standing boards are respectively fastened to the seat of said housing to hold said light emitting diodes in such a manner that the light-emitting heads of said light emitting diodes are respectively inserted through the lamp holes of said reflector and suspending between said reflector and said lens.

2. The LED vehicle lamp structure as claimed in claim 1, wherein said standing boards include at least two standing boards that have different heights.

3. The LED vehicle lamp structure as claimed in claim 1, wherein said standing boards include at least one standing board that has at least two light emitting diodes disposed adjacent to the top edge of the associating standing board at different elevations.

4. The LED vehicle lamp structure as claimed in claim 1, wherein said standing boards include a plurality of circuit boards.

5. The LED vehicle lamp structure as claimed in claim 1, further comprising a plurality of lead wires that electrically connect the light emitting diodes of said standing boards together.

6. The LED vehicle lamp structure as claimed in claim 1, wherein said seat has a plurality of mounting holes respectively fastened to said housing with screws.

7. The LED vehicle lamp structure as claimed in claim 1, wherein said seat has a plurality of guide grooves symmetrically provided on two opposite inside walls thereof; said standing boards are respectively inserted into the guide grooves of said seat.

8. The LED vehicle lamp structure as claimed in claim 7, wherein said guide grooves are respectively formed integral with the two opposite inside walls of said seat.

9. The LED vehicle lamp structure as claimed in claim 1, wherein said seat has fixedly mounted therein a circuit board, which has a plurality of insertion slots; said standing boards each have at least one gold leg respectively inserted into said insertion slots to electrically connect the respective light emitting diodes to said circuit board.

10. The LED vehicle lamp structure as claimed in claim 1, wherein said light emitting diodes are selected from at least one of the groups of red light emitting diodes, green light emitting diodes, blue light emitting diodes, yellow light emitting diodes, and white light emitting diodes.
